(19) United States
(12) Patent Application Publication
(10) Pub. No.: US 2010/0293389 A1
(43) Pub. Date: Nov. 18, 2010

(54) Playback of Information Content using Keys

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/467,284

(22) Filed: May 17, 2009

(51) Int. Cl. G06F 12/14; G06F 17/30; G06F 17/00; G06Q 30/00

(52) U.S. Cl. 713/189; 726/30; 700/94; 707/E17.008; 707/E17.101; 705/27

(57) ABSTRACT

Media, e.g., video, is played on a player that can store multiple items of video. Some video can be played using a stored key; other video needs to have an external key present. The key can decrypt the video or it can supplement the content of the video. If a request is made to play a video, that video can be automatically downloaded.

### BACKGROUND

Creators of media content, such as videos, music, audio books, and other content to be perceived by a user, lose money to theft: more specifically bootleg or other illegal copies of their content.

DVDs encrypted their content, but used a very weak encryption system. Any conventional DVD can be simply copied and redistributed by breaking the encryption code.

A more sophisticated encryption system has been used on Blu-Ray media. Even that encryption, however, is frequently compromised. Once a key has been compromised, it is no longer used. Consequently, many Blu-Ray devices need to periodically update their store of encryption and decryption keys.

However, once an encryption key for a Blu-Ray disc is broken, that Blu-Ray disc can be played by anyone who downloads a routine to play the broken Blu-Ray disc. Newer Blu Ray discs may have new encryption schemes. However, any encryption scheme that is used on many different disks can inevitably be broken.

My co-pending application Ser. No. 12/013,434 filed Jan. 12, 2008 describes a system that uses a read/write device for decryption information, where the read/write device is separate from the main media holding device, e.g., the disk.

### SUMMARY

The present application describes a system and method for distributing media content to a user, and restricting the operation so that only authorized users can actually use the content.

Another aspect describes a system where a single player can play a purchased media without an external provided key, and other players can play that purchased media, but only when an external key is inserted.

### BRIEF DESCRIPTION OF THE DRAWINGS

In the Drawings:

FIG. 1 shows a flow diagram of playing an item of media content such as a video; and

FIG. 2 illustrates a flow diagram of background processes.

### DETAILED DESCRIPTION

The goal of media content distributors is to allow authorized users access to the media content in the amount that they paid for, without undue hassle to those authorized purchasers. At the same time, however, that goal includes preventing unauthorized users from having access to the content.

Another goal, is to distribute the content in as inexpensive a way as possible. High-capacity discs such as DVDs and Blu-Ray discs are relatively inexpensive to produce in mass production.

These disks are relatively large (3-4 inches). Also, the information bearing surfaces on these disks are exposed, and hence they can be scratched or damaged.

An embodiment describes a wholly new way of protecting media against illegal playing and copying. The embodiments described herein include a number of different features, however it should be understood that any of these features can be used in any combinations.

In one embodiment, content is stored on the user's media player. The storage in the user's machine allows the user to play the stored content “on demand”. In one embodiment, a user “designates” one machine as their primary playing machine, and that machine may be allowed to play the media automatically and without entering any additional keys. However, the user can also physically insert the key in other machines, and those other machines can then also play the content, but only when the key is inserted.

That is, one machine plays the content most conveniently, totally from storage without entering a key. The content can also be played on other machines, but that playing on other machines is less convenient, requiring the key to be physically present at the time of playing.

In one embodiment, content is stored on the local machine, but only parts of the content are stored on the local machine for at least some of the content. This may keep a better control over the subject matter of the content. Parts that are not stored on the local machine are stored on the key, and the key can be used to fill in information, in essence provide a separate part of the content, to allow playing.

In embodiments, the players can freely download certain content. The content provider does not sell a media that includes the entire content, but rather only sells a key to the content. The content itself is downloaded, and can be played based on the information in the key. The non-key portions of the content are stored in local storage on a user's machine. For example, these machines may use a number of 1 TB storage units, for example 20-1 TB storage units. These storage units may be network accessible. 1000 movies of for example 20 gig each (blu ray size) could be stored on these 20 TB of storage.

Compare this with a user who wanted 1000 DVD or Blu Ray disks. This would mean 1000 disks in a rack, and the commensurate amount of space taken up by 1000 disks.

The “key” used by the embodiments can be a hardware key, which can be for example a miniature sized USB key. The USB key may include encryption hardware or decryption hardware therein, and/or may include portions of the content that make up the missing parts of the content that is stored on the local drive. The keys could be packaged in DVD style cases, and stored like DVDs. An alternative storage however, may put many keys in a smaller box. A standard size paper box or shoebox could hold hundreds of USB keys.

The term “encryption” is used herein to represent changing the content in a way that prevents it from being completely played without some kind of additional information, e.g., a key. The “encryption” can be by changing the content using mathematical encryption techniques, e.g., by strong cryptography, in which case the key is a cryptographic key. It may also, in other embodiments, use scrambling or removal of all or parts of the content, or by changing the meaning of certain different items within the content, in which case the key includes the missing information.

In one embodiment, the content is downloaded and stored locally. The key is sold to allow viewing the content.

For purposes of this embodiment, the description will refer to movies, however it should be understood that the system can use any media content now known or later discovered.

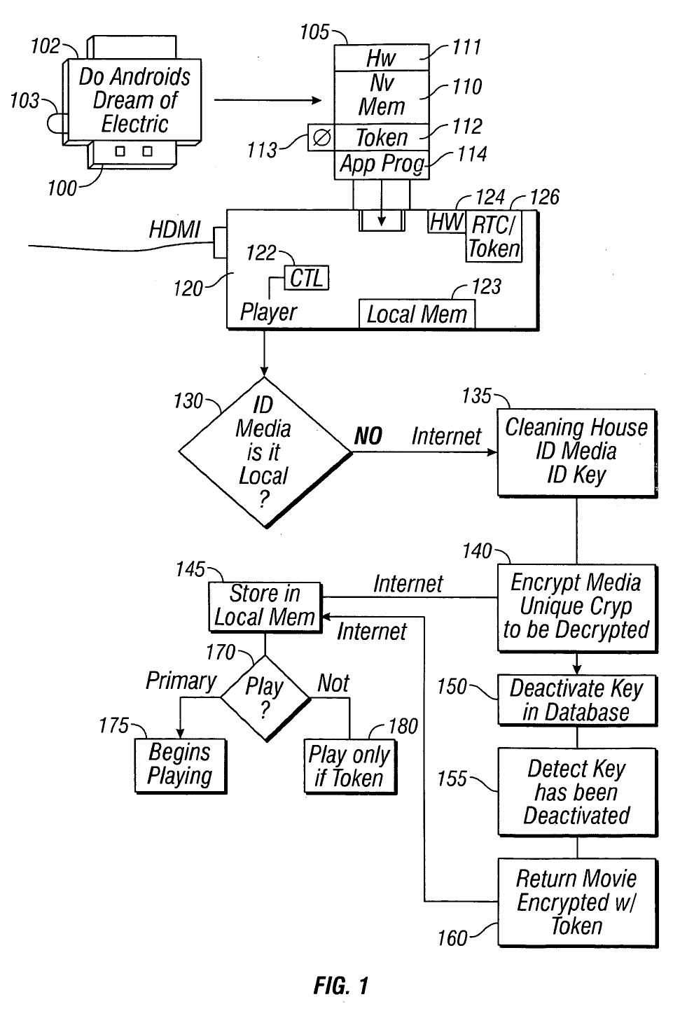

The operation according to an embodiment is illustrated with reference to FIG. 1. The “key” may be a solid-state USB memory with a USB connector 100 that plugs into a corresponding port on the media player. The USB key may be marked with the name of the media that it can be used to play. The body of the USB key is shown as 102, and a block diagram of the USB key is shown as 105. The key includes a nonvolatile memory 110 which includes information that is used for playing the content. In embodiments, that can include decryption information and/or other information. According to the embodiment, the system can also include hardware information 111, and token information 112. The token or other hardware can use a real-time clock shown as 113. If desired, the operation may be controlled by an application program 114.

The key 105 is coupled to a corresponding port of a local player shown as 120. The player 120 includes an output port, such as a high definition video audio output e.g. HDMI. In another embodiment, the operation uses wireless HDMI, and the decryption is carried out in the video unit.

When the key 105 is present relative to the unit, e.g., when it is inserted into the unit, it automatically runs the application program 114. In an alternative embodiment, all or part of the application program may be resident within the player 120. The operation is coordinated by a controller 122 within the player.

In another embodiment, the key can have wireless capability, e.g., wireless USB or wireless 802.11 capabilities, and can be determined as being physically present when placed close to the unit.

First, information from the key is written to a local memory shown as 123. At 130, controller 122 causes the player to identify the media represented by the information 110/111, and determine if the media to be played has been locally stored. If not, the application program controls communicating over a network, e.g., the internet or some other network. The communication can be to either a supplier of the media, or, for example, a clearinghouse that has been designated by a number of different media providers.

The clearinghouse may include versions of the media for downloading. At 135, the clearinghouse identifies the media and also identifies the key by an identification associated with the key. The key identification may use the hardware identification code 111 which may be a unique hardware identifier for the specific key. It may also recognize token information, which is an encryption key or an encryption code that depends on both either the hardware key 111 or some other unique key in the device, and also depends on a value provided by the real time clock 113.

At 140, the clearinghouse creates or otherwise returns a special version of the content that can only be read using the specific key 105 that made the request. A preferred embodiment may encrypt the movie using a strong encryption that can only be decrypted using keys on the hardware key 105. Other embodiments may use other forms of changing the movie as described herein. The returned movie is referred to herein as being “encrypted”; however, the form of the movie changing can be used.

Another embodiment may have several (e.g., 5-20) keys, and may return a version of the content that is based on the specific key entered. This embodiment does not need to form unique versions of the content for every download, but instead downloads one of many different stored versions. Not all keys, however, will be able to play all stored versions, making some security from this process.

In one embodiment, the key may be a hardware key 111 that has a fixed value. In another embodiment, the key may use the value from the token 112. In order to break the encryption scheme, a user would have to break their own encryption scheme, which is one of many different schemes for different users. This would give the user access only to that one version of the media—however, not to all other media that have been downloaded by others.

The encrypted movie is returned over the Internet, block by block, and stored at 145 in the local memory 123 in the “P” section of the local memory 123. The P section stores “personalized” movies which have been downloaded and are associated with a hardware key.

The movies downloaded in this way can be played by the specific player 120 using information from the key 111—but the key need not be physically present to play the movie. Information from the key may also be stored, for example in HW section 124, to enable playing the movie without the key present.

In one embodiment, the key can only be used to activate a single player to play the movie without the key present. After storing at 145, the key is deactivated in the database of the clearinghouse at 150. After deactivating the key in the clearinghouse, it cannot be used again to download a movie with this cryptographic script that allows the movie to be played without a key present.

155 represents detecting a key that has been already been used once being inserted into the player 120. In this embodiment, the user can use can still use the deactivated keys for watching a movie—however, the movie can only be played when the deactivated key is actually present within the unit. This produces a special advantage. For a “primary” player, e.g. the first player that receives the key or a player that is selected as being primary once the key has been entered, a movie is downloaded with an encryption that can be decrypted by information stored in the local player. The hardware key 111 may be stored in the local memory 123 and can be used to decrypt the encrypted movie that is stored therein. Security measures may be taken including the use of a cryptographic boundary, such as described in my co-pending application co-pending application Ser. No. 12/013,434 filed Jan. 12, 2008, in order to protect the encryption contents. However, for all other players, the users can the user can still view the movie, but can only view the movie when in possession of the key. The user can freely play the content on the primary player. The content can be played on other players too by an authorized user, but that authorized user must have the key in order to do that.

At 160, after detecting a key that has been deactivated, the clearinghouse returns a movie encrypted in a way that can only be played with the key present. For example, this may encrypt using token encryption, so that that movie can only be played when the specific token 112 from the specific key 105 is present. This movie is encrypted differently than the movie returned at 140. This movie may also be stored in the P section of the memory 123.

At 170, a play request is detected, which determines whether this is a primary player or not. If the play request is for a movie that is a primary player, the movie begins playing at 175. Note that the movie can play entirely from the local memory, no external hardware at all is necessary at this point. The movie has been downloaded, and also the encryption key has been stored in the local memory. Therefore, the playing can be totally selected from a menu on the player.

However, when the play routine is for a non-primary player, it can be played only if the token is attached at 180. The decryption uses the presence of the token to decrypt the stored movie.

In the embodiments, different other features are also possible. In one embodiment, the decryption and in the movies that are stored locally on the primary player may also be further encrypted with unique information from the player. For example, the player may include its own hardware decryptors such as a unique processor identification code in the code section 124. It may include its own real-time clock/token ID 126. In this way, simply removing the information or simply downloading the information from the hard drives will not allow others to play the movie.

Another embodiment may use weaker encryption techniques, where the player decides which movies it can and/or cannot play at 170/175/180, without using encryption techniques. In this embodiment, the player refuses to play movies that do not pass the software tests. In this embodiment, the movies can be stored unencrypted or with weak encryption or with stronger encryption—but the determination of whether to play the movie is made by the player.

According to another embodiment, the key 102 has a special button 103 thereon. The button may be pressed to indicate “play”, and when pressed, it causes the application program e.g. 113 to indicate to the playing system, to automatically play the media. The button depression may be stored by the key 102 for 1-2 minutes, and may, for example, automatically cause playing of the video after the key is inserted after the button has been pressed within the specified time.

In another embodiment, the media may autoplay at all times, once inserted, or may go to a menu that allows playing after insertion, or the button may prevent autoplay and bring up the menu.

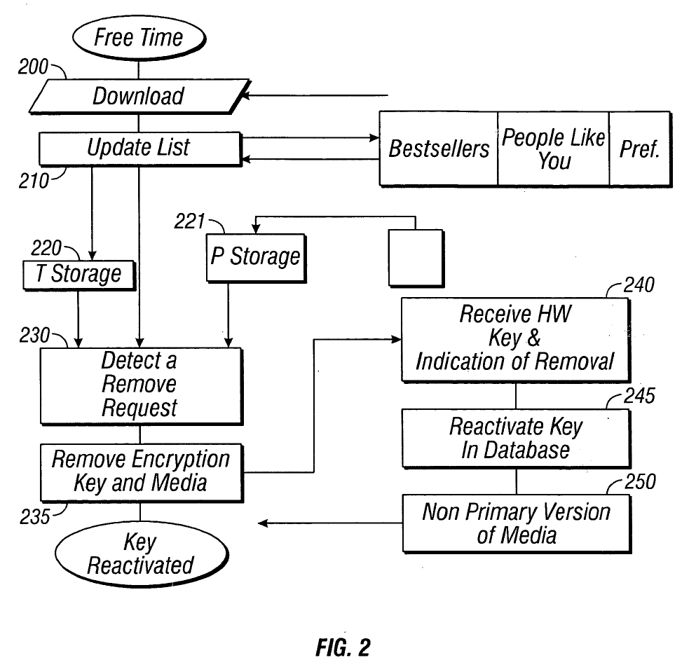

The media player may also run a free time routine shown in FIG. 2. Part of the power of this media player is its ability to store a number of different items into its memory 123. During his free time, for example, the media player may be continuously downloading movies which it believes the user might want to watch. These movies that are downloaded without the user's specific request may be stored in the “T storage” or temporary storage. The user can play these movies form the T storage.

200 generally represent downloading the movies from the clearinghouse as desired. These movies which are downloaded can be encrypted in a special way, or can be partial movies. For example, the download may be a download of 75% of the movie, with the remainder of the movie being downloaded on demand. The downloads 200 may be based on a list that the player has already requested for download, and may include for example the top 10 movies, or the top 10 movies that the user might find interesting. At 210, a list update is carried out. This is done by sending a request to the remote clearinghouse, and receiving the new list. As described above, that new list may include bestsellers and may also include movies that “people like you found interesting”, based on the movies that the user has actually watched. Again, these movies may be added to the download list, and later downloaded at 200.

There may also be a preferences list, that can be manually created by a user, for example a wish list of things the user might want to see, and these movies or part movies or previews can be downloaded. The downloaded movies are preferably encrypted or otherwise protected by the player, so that the player cannot play these movies without a proper key.

The download is stored into memory 123 into T storage, at 220. The T storage is used for movies where the user has not entered the key. These movies can be deleted to make room for other movies, but can also be played or partly played by a user. This contrasts with the P storage which is used for movies where the key has been entered. Those movies in P storage are not freely deleted to make room for other movies.

The P storage movies may also be part of the downloading, and are hence shown is 221. P storage downloads on the download list 200 are placed to the top of the download list, and are carried out at a higher priority.

Movies in T storage can be previewed and/or played. If a user gets a key for a movie in T storage, the movie is recoded according to the key and placed in P storage. However, since all or part of the movie has already been stored, this removes the need to have a fast download capability.

A user can also purchase a key for the movies in T storage using an internet-based store, and receive that key by download. The player then becomes a primary player for that movie. The physical key might be mailed to such a user. Another embodiment may allow a user to use any USB devices that they already have to receive such a key as downloaded, and that USB device may become the key to use for other players. If the key contains information for multiple movies, a menu is displayed when the key is inserted.

In this and any other embodiment where information is transferred to the player, the information may be encrypted using public/private keys, such as PGP encryption, to prevent the encryption or transcoding information from being intercepted.

One problem with the download technique is that either very fast downloads must be carried out, or lags in the movie may be expected. The storage of movies in T storage may address this problem, since all or part of a movie is stored in T storage, making a fast playing.

In one embodiment, the hardware key 105 may store the first 15 minutes of the movie so that the user can watch the movie while the remainder of the movie is being downloaded, thereby ensuring no lags at least for the first 15 minutes.

Another embodiment may store a complete copy of the movie on the key.

Yet another embodiment stores a low resolution copy of the movie on the key (optionally with a complete copy of the first 10-20 minutes of the movie). The download made is then of enhancement information which improves the viewed quality. For example, the key may store a 320×200 resolution version of the movie, with mp3 audio; information for the remaining resolution (e.g., up to 2580×1930 with DVD audio) being downloaded. Lags in the download do not prevent the playing, but rather cause parts of the played video to degrade in quality.

Another embodiment may download the lower quality version of the video at higher priority, so that the lower quality version can immediately be played, while the higher quality parts are downloading the background.

Another housekeeping function at 230 is the detection of a remove request. In the above, the first player that actually receives the key becomes the primary player, and that player they can always play the movie without the key present. All other players can play the movie, but only when the key is actually present.

However, this embodiment makes it also possible to remove the the association of being primary, so that another player can be made the primary. When a remove request is received at 230, the encryption key is removed at 235. The media can be removed from P storage and sent to T storage, for later transcoding if necessary.

The hardware key to be removed is then sent to the clearinghouse at 240, along with an indication of that removal.

At 245, the key is reactivated in the database of the clearinghouse. At the same time, either a non-primary version of the media may be added to the download list at 250 (that can be played only with the key present). Alternatively, transcoding instructions for the media can be provided to transcode the movie into one that can be played with the key present, or to change the playing permissions.

At 250, the key can then be used the key is reactivated and can be used to make another primary key for another device.

An important feature is features of the encryption or decryption done by the key. The way in which the key is used, called encryption in some embodiments, may be done in any of a number of different ways as described herein.

In one embodiment, the key can be the key described in my co-pending application Ser. No. 12/013,434 filed Jan. 12, 2008, that encrypts and allows a certain number of uses.

In another embodiment, the “encryption” information in the key may actually be frames for use as part of the movie. For example, the key may store keyframes for the movie, while the downloaded media includes only the motion vectors and other information for the movie that is used in addition to the keyframes,. These keyframes may be encrypted or non-encrypted, since watching only the keyframes will provide an unsatisfying view of the movie.

Another embodiment may include keyframes for only part of the movie, for example for the first 10 minutes, or for a 10 minute sequence, followed by a blank, followed by another 10 minute sequence.

In another embodiment, the key may be store the opposite—only the motion vectors, so that only keyframes for the movie are part of the downloaded media information. The non-keyframe information is then downloaded.

In yet another embodiment, the key can be any kind of mathematical based decryption key, for all or part of a numerically-encrypted movie.

In yet another embodiment, the key can simply be an indication of the meaning of the improvement information. For example, the key may indicate whether the stored motion vector represents information about a previous frame, a new frame, left motion or right motion. Without that information, the motion vector information is not necessarily usable, since its function is not necessarily understandable.

Another embodiment stores improvement information in the key, e.g., to improve the resolution of video and/or audio.

Other embodiments are contemplated. For example, other encryption schemes can be used. Any “encryption” can be replaced by any way of preventing unauthorized playing of the video, e.g., the removal of parts, reduction in resolution, etc. The encryption can also simply be set as playing permissions in the player.

Also, some content can be designated as un-protected, and that content can be freely played by the player, without needing a key or permissions. For example, this could include certain videos or content which an owner wishes to be freely distributable.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The system as disclosed can be a media player, e.g., a DVD or Blue Ray player, an MP3 or avi video player, a digital video recorder or other hardware. The techniques described herein can also be done wholly in software on a general purpose computer.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

1. A media player comprising:
a playing part which plays media information, wherein said playing part determines whether the media information is a first kind of media which can be played on the playing part without a physical device being present, and plays said first kind of media without a physical device being present, and determines whether a physical device is present when said media is not said first kind of media and plays said media which is not said first kind of media completely only when information on said physical device is related to said media and of a type that controls playing said media.

2. A media player as in claim 1, further comprising a media store, that stores said media for playing, and stores information indicative of whether said media is said first kind of media.

3. A media player as in claim 1, wherein said playing part uses information on said physical device to mathematically decrypt contents of said media for playing.

4. A media player as in claim 1, wherein said media player further stores permission information which indicates whether said media can be played without said physical device being present, and prevents playing media which cannot be played without said physical device being present, unless said physical device is present.

5. A media player as in claim 1, wherein said physical device is physically connected to said player.

6. A media player as in claim 1, wherein said media player stores a designation for each of a plurality of content, or whether said media player is a primary playing machine for that content, and designates said media as being a first kind of media which can be played on the playing part without a physical device being present when said media player is a primary playing machine for that content.

7. A media player as in claim 1, wherein said player uses information on said physical device to supplement other content of said media, and wherein said playing part plays using both content of said media and also content from said physical device together for playing.

8. A media player as in claim 2, wherein said playing part detecting a request to play a specific media information, determining if said specific media information is stored in said media store, and if not, automatically controls downloading said specific media information and storing downloaded information in said media store.

9. A media player comprising:
a playing part which plays media information;
a storage part which stores said media information for playing;
said playing part detecting a request to play a specific media information, determining if said specific media information is stored in said storage part, and if not, automatically controls downloading said specific media information.

10. A media player as in claim 9, wherein said playing part determines whether the media information is a first kind of media which can be played on the playing part without a physical device being present, and plays said first kind of media without a physical device being present, and determines whether a physical device is present when said media is not said first kind of media and plays said media which is not said first kind of media completely only when information on said physical device is related to said media and of a type that controls playing said media.

11. A media player as in claim 10, wherein said playing part uses information on said physical device to mathematically decrypt contents of said media for playing.

12. A media player as in claim 10, wherein said media player further stores permission information which indicates whether said media can be played without said physical device being present, and prevents playing media which cannot be played without said physical device being present, unless said physical device is present.

13. A media player as in claim 10, wherein said media player stores a designation for each of a plurality of content, or whether said media player is a primary playing machine for that content, and designates said media as being a first kind of media which can be played on the playing part without a physical device being present when said media player is a primary playing machine for that content.

14. A media player as in claim 10, wherein said player uses information on said physical device to supplement other content of said media, and wherein said playing part plays using both content of said media and also content from said physical device together for playing.

15. A media player as in claim 9, further comprising an external memory, in addition to said storage part, where said additional memory stores parts of the media for playing.

16. A media player as in claim 9, wherein said storage part stores first media that has been purchased and second media that has not been purchased and which is in a form that cannot be completely played without purchase.

17. A media player as in claim 9, wherein said playing process also detects if said specific media information has been purchased, and allows playing said media information only if purchased, and wherein a specific media information in aid storage unit which has not been purchased is not allowed to be played.

18. A method of playing media, comprising:
receiving a request to play a stored item of media;
determining if a key for the stored item of media has been stored, and if so playing said stored item of media using said key;
if no key has been stored, then playing said stored item of media only if said key is present on an external device.

19. A method as in claim 18, further comprising enabling a preview of said media where no key has been stored, even when said key is not present on said external device.

20. A method as in claim 18, wherein said playing uses information on said physical device to mathematically decrypt contents of said media for playing if no key has been stored.

21. A method as in claim 18, wherein said key includes permission information which indicates whether said media can be played without said physical device being present, and prevents playing media which cannot be played without said physical device being present, unless said physical device is present.

22. A method as in claim 18, wherein said player uses information on said physical device to supplement other content of said media, and wherein said playing part plays using both content of said media and also content from said physical device together for playing.
